(19) United States
(12) Patent Application Publication
(10) Pub. No.: US 2009/0048094 A1
(43) Pub. Date: Feb. 19, 2009

(54) SULFUR-RESISTANT NOBLE METAL NANO-PARTICLES ENCAPSULATED IN A ZEOLITE CAGE AS A CATALYST ENHANCER

(76) Inventors: Zbigniew Ring, Edmonton (CA); Hong Yang, Edmonton (CA)

Correspondence Address: KIRBY EADES GALE BAKER, BOX 3432, STATION D, OTTAWA, ON, K1P 6N9, CA

(21) Appl. No.: 11/837,852

(22) Filed: Aug. 13, 2007

(51) Int. Cl. B01J 29/068

(52) U.S. Cl. 502/74; 502/87

(57) ABSTRACT

A sulfur resistant catalyst is taught having noble metal nano-particles contained in a zeolite cage having a final pore size of between about 2.9 Å and about 3.5 Å. The zeolite cage is either directly synthesized, or the final pore size of the zeolite cage is reduced by post-treatments selected from chemical vapour deposition, chemical liquid deposition, cation exchange and combinations thereof to allow passage of hydrogen molecules into the cage while excluding organic sulfur molecules. Disassociated hydrogen species from reaction with the noble metal spill over through the zeolite pores to induce hydrogenation and to regenerate neighboring catalyst supports. A method is also taught for producing a sulfur resistant catalyst having noble metal nano-particles. The method involves either synthesizing a zeolite cage having a final pore size of between about 2.9 Å and about 3.5 Å or reducing the size of pores in the zeolite cage by a post treatment selected from chemical vapour deposition, chemical liquid deposition, cation exchange and combinations thereof.

### FIELD OF THE INVENTION

The present invention relates to noble metal catalysts that are often used in hydrogenation and other reactions that are resistant to sulfur.

### BACKGROUND OF THE INVENTION

Noble metal-promoted catalysts are widely used to carry out hydrogenation, dehydrogenation, isomerization, aromatization and oxidation reactions. They also find application in the treatment of gaseous emissions containing diluted organic compounds by catalytic combustion. For example, zeolite membranes with dispersed platinum are used to enhance hydrogen selectivity during separation of hydrogen-containing gas streams. Also, membrane reactors with platinum-containing membranes are used to separate hydrogen from reaction mixture in reforming or dehydrogenation processes to overcome the thermodynamic equilibrium limitations.

Although noble metal catalysts are very active in the applications listed above, they are extremely susceptible to poisoning by sulfur, which is often present at only a few parts per million concentrations, and such catalysts can only be used if the sulfur content in the feed has been sufficiently reduced in a separate stage. Development of sulfur resistant noble metal catalyst has always been a great challenge.

Several approaches have been tried to improve the sulfur resistance of noble metal catalysts. Platinum supported on an acidic zeolite support was reported to be more sulfur-resistant than platinum supported on alumina. This was explained by stronger electron transfer to the acidic sites of the zeolite which made platinum clusters more electron deficient. The sulfur-tolerance of platinum clusters can be further improved by the addition of palladium or by using chlorine or fluorine as a promoter using the electron deficient concept. These methods may increase the sulfur-tolerance of the noble metal but they cannot completely eliminate the sulfur poisoning effect. The feed still needs to be pretreated before using the noble metal catalysts. In particular, these methods alter the affinity of sulfur to the platinum site, but cannot prevent contact between sulfur molecules and noble metal nano-particles.

Other approaches have attempted to use a zeolite support having a two pore system wherein some noble metal nano-particles are located in small pore openings (less that 5 Å), whereas others are contained in larger pore openings (greater than 6 Å). Diffusion of organo-sulfur compounds such as thiophenic molecules into the small pores is inhibited and the large pore allows fast diffusion and reaction of bulky polycyclic aromatics and sulfur molecules. Hydrogen molecules can readily enter both sizes of pores, dissociatively adsorb on metal nano-particles, and be transported between pore systems by hydrogen spillover. When the metal nano-particles in large pores become inactive by adsorbed sulfur molecules, spillover hydrogen could recover the poisoned metal sites. However, this approach does not consider the presence of aliphatic sulfide and small sulfur molecules in the feed, or the high reactivity of thiophenic molecules.

Aliphatic sulfur compounds such as ethyl sulfide and propyl mercaptan are small enough to enter the 5 Å pore. Further more, those aliphatic sulfides and thiophenes can be converted into H₂S easily at very low temperature, and therefore cause deactivation of noble metal nano-particles inside of the small pores.

Although the concept of incorporating Pt nano-particles into a zeolite cate has been used before, there has been no attempt o protect noble metal nano-particles from exposure to sulfur.

### SUMMARY OF THE INVENTION

A sulfur resistant catalyst comprising noble metal nano-particles contained in a zeolite cage having a final pore size of between about 2.9 Å and about 3.5 Å. The zeolite cage is either directly synthesized, or the final pore size of the zeolite cage is reduced by post-treatments selected from chemical vapour deposition, chemical liquid deposition, cation exchange and combinations thereof to allow passage of hydrogen molecules into the cage while excluding organic sulfur molecules. Disassociated hydrogen species from reaction with the noble metal spill over through the zeolite pores to induce hydrogenation and to regenerate neighboring catalyst supports.

The present invention also provides a method of producing a sulfur resistant catalyst comprising noble metal nano-particles. The method comprises incorporating the noble metal nano-particle into a zeolite cage and then reducing the size of pores in the zeolite cage to between about 2.9 Å and about 3.5 Å by a post treatment selected from chemical vapour deposition, chemical liquid deposition, cation exchange and combinations thereof. This allows passage of hydrogen molecules into the cage while excluding organic sulfur molecules. Disassociated hydrogen species from reaction with the noble metal are allowed to spill over through the zeolite pores to induce hydrogenation and to regenerate neighboring catalyst supports.

A method is also provided for producing a sulfur resistant catalyst comprising noble metal nano-particles. The method comprises synthesizing a zeolite cage having a final pore size of between about 2.9 Å and about 3.5 Å to allow passage of hydrogen molecules into the cage while excluding organic sulfur molecules. The noble metal nano-particles are then incorporated into the zeolite cage. Disassociated hydrogen species from reaction with the noble metal are allowed to spill over through the zeolite pores to induce hydrogenation and to regenerate neighboring catalysts.

### BRIEF DESCRIPTION OF THE DRAWINGS

The present invention is herein explained in further detail with reference to the following drawings wherein:

FIG. 1 is a schematic diagram illustrating the concept of the sulfur resistant noble metal hydrogenation catalyst of the present invention;

FIG. 2 is a graph comparing hydrogen uptake before and after H₂S poisoning;

FIG. 3 illustrates one embodiment of the methods of the present invention; and

FIG. 4 illustrates another embodiment of the methods of the present invention.

### DETAILED DESCRIPTION OF THE PREFERRED EMBODIMENTS

In the present invention, a family of sulfur-resistant noble metal catalysts have been developed using a combination of shape selective and hydrogen spillover concepts. For the purposes of the present invention, shape selective concept is defined as the idea of controlling what size and shape of molecules come in contact with the noble metal nano-particles by preventing unwanted molecules from diffusing in and out of the zeolite cage. The concept of hydrogen spillover is that hydrogen molecules that are dissociatively adsorbed on the noble metal clusters, then spill over and provide a continuous source of spillover hydrogen species to the neighboring catalyst supports. These spillover hydrogen species can hydrogenate the aromatics molecules adsorbed on the neighboring catalyst support; they can also continuously regenerate the neighboring unprotected catalytic sites. The poisoning effect of sulfur molecules on noble metal catalysts is significantly reduced and even eliminated this way.

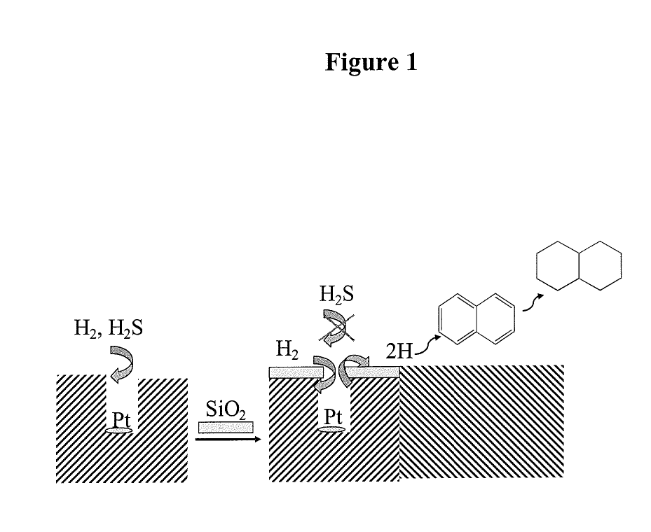

In order to make the noble metals sulfur resistant, the noble metal nano-particles are encapsulated in zeolite cages by directly incorporation during synthesis or by well know ion exchange methods into the zeolite cage. By choosing a specific synthetic zeolite or by post treatments such as the deposition of amorphous or nano-crystalline materials or cation exchange or by both means, the pore opening to the zeolite cage can be reduced to an opening small enough to only allow hydrogen species, having a kinetic diameter of about 2.9 Å, to diffuse in and out while physically excluding organic sulfur molecules, including even very small molecules such as hydrogen sulfide, having a kinetic diameter of only 3.6 Å. In this way, the noble metal is not merely less likely to be poisoned by sulfur species; all contact between the noble metal and even the smallest sulfur molecules is avoided. The method is illustrated schematically in FIG. 1.

Noble metals suitable for encapsulation by the present methods can include any transition metal that can adsorb hydrogen or have hydrogenation capacity. Preferred metals are metals in group VIIIB of the periodic table, including Pt, Pd, Ru, Ir and Re, Particularly preferred are platinum and palladium.

Although noble metals are a preferred focus of the present invention, the inventors note that the present methods can also be used to make sulfur resistant catalysts comprising other metals such as, for example, nickel, cobalt and tungsten, by encapsulating nano-particles of these metals into the zeolite cages of the present invention.

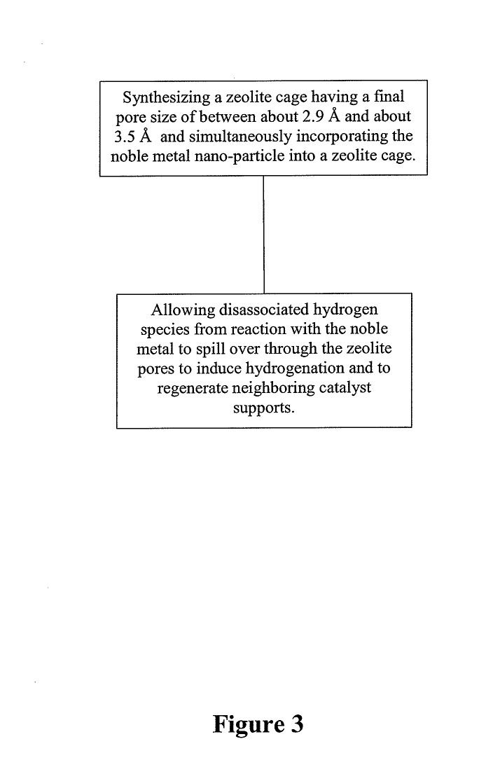

The zeolite used for the present invention can be directly synthesized with the desired final pore size and the noble metal nano-particles can be incorporated into the synthesis mixture simultaneously. Suitable synthesized zeolites include any type of zeolite having pore openings similar in size to hydrogen sulfide molecules will work. FIG. 3 illustrates a general method of encapsulating a noble metal nano-particle into a directly synthesized cage.

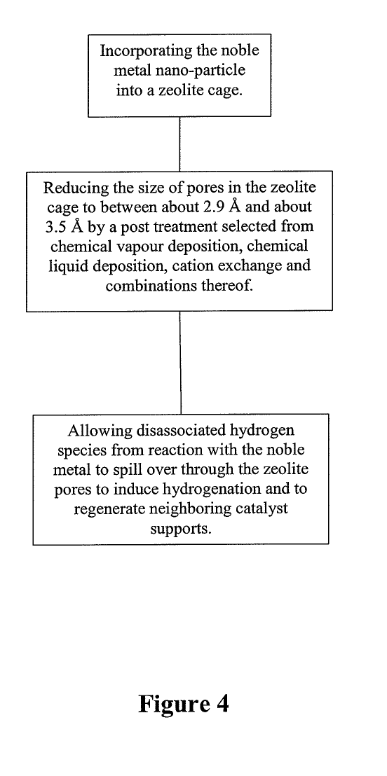

Alternately, the final pore size of the zeolite cage can be reduced after encapsulation of the noble metal. The final pore size can be reduced by such post-treatment methods as chemical vapour deposition, chemical liquid deposition and cation exchange, and combinations thereof. FIG. 4 illustrates a general method of encapsulating a noble metal nano-particle into a zeolite cage using one or more post-treatments to reduce final pore size.

Preferably, a zeolite with an alpha or beta cage is used. Examples of suitable synthesized zeolites include, but are not limited to faujasite, LTA, RHO, sodalite, chabazite.

In cation exchange, the positively charged ions of zeolite are preferentially replaced by positive ions of another chemical. Chemical reagents that have been found to be suitable for cation exchange are salts containing the desired cations, for example the chloride or nitrate of alkali metals and alkaline earth metals such as sodium, potassium, cesium, magnesium and calcium. Also preferred is potassium chloride (KCl).

Chemical vapor deposition (CVD) and chemical liquid deposition (CLD) are also used, either on their own or in combination with cation exchange to reduce final pore size. Chemical reagents preferred for pos-treatment are those which are effective in surface silanization and include, but are not limited to alkoxysilanes such as tetramethoxysilane and tetraethyoxysilane, silanes (SiH4), chlorosilane and halide silanes such as trimethylchlorosilane. Most preferred is tetraethoxysiliane (TEOS)

Suitable neighboring catalyst supports are those that accept spillover hydrogen and can include zeolites, metal oxides, alumina, silica, activated carbon, carbon molecule sieves. Most preferred is a mixture of zeolite Y and γ-alumina.

### EXAMPLE

The following example serves to merely illustrate particular aspects of the invention, and in now way represents the scope of the invention as a whole.

### 1. Preparation of Pt/Na(K)A-zeolite

Sodium aluminate (Na₂O. Al₂O₃. 3H₂O) and sodium metasilicate (Na₂SiO₃) were used as aluminum and silicon sources, respectively. Three solutions were prepared for the synthesis: A) sodium aluminate in deionized water; B) sodium meta silicate in deionized water; C) Pt(NH₃)₄Cl₂ in deionized water. Solution A was first combined with solution C, to which was added solution B. The mixture was heated up to reflux and reacted under stirring for 7 hours. The solid product was separated from the liquid phase by filtration and washed repeatedly with deionized water. The Pt/NaA-zeolite was ion-exchanged three times with 0.5 N KCl solution at 80° C. The solid was thoroughly dried at room temperature, then it was dried at 120° C. for 2 h before calcination at 400° C. for 2 h. Pt/KA-zeolite was then subjected to two chemical vapor deposition (CVD) cycles to further reduce the pore opening. In the CVD step, 2 g of catalyst was placed in the middle of a fixed bed quartz reactor. Helium was flowed through a saturator that was filled with tetraethyoxysilane (TEOS) at 50° C. and then directed to the reactor. The chemical vapor deposition was conducted at 300° C. and followed by a calcination step at 400° C. to create new Si—OH sites for the next cycle. The TEOS-treated catalyst was named as TEOS_Pt/KA-zeolite. A blank KA-zeolite was synthesized the same way as Pt/KA-zeolite without the presence of the Pt precursor.

### 2. Hydrogenation Reaction

Four catalysts were tested: 1) blank KA-zeolite (20 wt %) diluted with HY-zeolite (60 wt %) and γ-alumina (20 wt %); 2) Pt/KA-zeolite without dilution; 3) TEOS-Pt/KA-zeolite (20 wt %) diluted with HY-zeolite (60%) and γ-alumina (20%); 4) Pt/KA-zeolite (20%) diluted with HY-zeolite (60%) and γ-alumina (20%). The fourth catalyst was used to investigate the effect of TEOS coating on the hydrogenation activity. HY-zeolite (CVB720) was obtained from Zeolyst International (Valley Forge, Pa.). The powders of the catalyst components were first physically mixed, then the mixture was pressed into pellets, which were crushed into 0.15 to 0.30 mm in size before being used as the final catalyst. In the hydrogenation test, 3 mL of catalyst was mixed with 3 mL of glass beads (0.25 mm) before it was loaded into a fixed-bed microreactor (0.635×30.5 cm) operated in the continuous up-flow mode. The catalyst was reduced in-situ at 400° C. over night by a flow of hydrogen (350 mL/min) at 6.8 atm. Hydrogenation of naphthalene was carried out at 69 atm, 350° C., with a liquid hourly space velocity (LHSV) of 2.0 h⁻¹ and a hydrogen to liquid ratio of 1000 NL/L. Pure hydrogen was replaced by 3% H₂S in H₂ to test the sulfur resistance of the catalyst. Two back-to-back mass balance runs were conducted 24 hours after the reaction conditions were reached. Five weight percent of naphthalene in n-heptane was used as feedstock. The feed and the products were analyzed by a HPLC equipped with a Partisil 5 PAC column (Wharman) and a refractive index detector (Water) using 100% heptane as the mobile phase. The conversion of naphthalene was used as a measure of hydrogenation activity. Turn over frequency (TOF) was also calculated using first order kinetics as an approximate measure for hydrogenation reaction rate constant to compare the catalyst activity based on platinum.

### 3. Results and Discussion

### 3.1 Preliminary Test for Sulfur Resistance

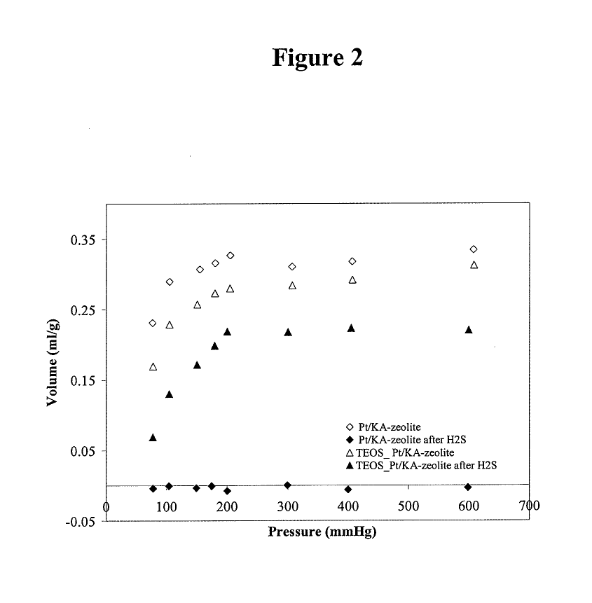

Catalysts that showed promising results were further tested for hydrogenation activity in the fixed-bed reactor. In this case, the catalyst was submitted to a first hydrogen chemisorption analysis, then a second hydrogen chemisorption analysis after it was exposed to 5% H₂S in hydrogen for 30 min at 230° C. FIG. 2 compares the H₂ uptake for TEOS_Pt/KA-zeolite and Pt/KA-zeolite before and after H₂S poisoning. After the exposure to H₂S, the TEOS_Pt/KA-zeolite retained over 60% of its original hydrogen adsorption capacity, while a complete loss of hydrogen adsorption capacity was observed for Pt/KA-zeolite that was not treated with TEOS. These results show that through TEOS treatment; in TEOS_Pt/KA-zeolite, at least 60% of platinum particles located in the zeolite pores had diameters less than that of H₂S but larger than that of H₂. The rest of the platinum particles were probably found inside the pores with diameters larger than 3.6 Å, due to insufficient TEOS treatment. The experiment successfully demonstrated that platinum particles inside of zeolite pores were protected from exposure to H₂S due to shape selective effect.

### 3.2 Hydrogenation of Naphthalene

The hydrogenation activity tests of the catalysts were conducted in a small fixed-bed continuous reactor at 350° C., 69 atm of hydrogen pressure and liquid hourly space velocity (LHSV) of 2.0 h⁻¹. 5 wt % of naphthalene in n-heptane was used as the feed. Two back-to-back runs were conducted at each condition when the reactions reached steady-state as determined by measuring the density of the liquid product. Averaged results from the two runs were used. The conversion of naphthalene was followed by a HPLC. The turn-over frequency was calculated assuming first order kinetics for the hydrogenation reaction.

Table 1 presents the compositions of catalyst mixtures, the conversions of naphthalene and the TOF of corresponding catalysts.

TABLE 1
Comparison of naphthalene hydrogenation activity
(69 atm, 350° C., LHSV 2.0)

| | Conversion of | TOF |
|---|---|---|
| Catalyst mixtures | naphthalene (%) | s⁻¹ Pt⁻¹ |
| KA-Zeolite + HY-zeolite + γ-alumina | 1.62 | NA |
| Pt/KA-zeolite | 1.51 | 0.45 |
| TEOS_Pt/KA-zeolite + HY-zeolite + | 9.7 | 6.3 |
| γ-alumina | | |
| switch from pure hydrogen to 3% H₂S | 3.9 | 2.4 |
| Pt/KA-zeolite + HY-zeolite + γ-alumina | 23.11 | 15.6 |

When pure hydrogen was used as treat gas, the naphthalene conversion over the blank catalyst (without Pt)—a mixture of KA-zeolite, HY-zeolite, and γ-alumina—was 1.62%. A comparable conversion of 1.51% (TOF: 0.45) was obtained over Pt/KA-zeolite with no diluent added. Since naphthalene is too bulky for the pore opening of KA-zeolite, and can be converted only over the support and the surface platinum particles, we can assume that the 1.51% conversion was caused by the support and practically all platinum particles were located inside the zeolite pores. In the case of the hybrid catalyst—a mixture of TEOS_Pt/KA, HY-zeolite, and γ-alumina—naphthalene conversion of 9.7% (TOF: 6.3) was reached. When pure hydrogen was replaced by 3% H₂S in hydrogen, the hybrid catalyst system retained 38% of its original hydrogenation activity based on the numbers of active metal, indicating that the present catalyst is highly sulfur tolerant.

As mentioned above, H₂ chemisorption shows that 60% of the initial hydrogen uptake was preserved after H₂S poison. The discrepancy between the sulfur resistance of platinum in H₂ chemisorption and the pilot plant test is probably due to the difference of the two systems. Chemisorption was conduced at 35° C. and low H₂ pressure, while the pilot plant test was conduced at high H₂ pressure, 350° C. and in the presence of naphthalene and heptane. The last row in Table 1 shows that the catalyst Pt/KA-zeolite has significantly higher hydrogenation activity compared to that of TEOS-treated Pt/KA-zeolite, which shows a loss of catalyst activity due to silica deposition.

Hydrogen spillover refers to surface diffusion of hydrogen surface species from the metal sites where they are produced by the dissociation of hydrogen molecules to the oxide support that has no activity for dissociative hydrogen adsorption. The hydrogen species could be consumed in a hydrogenation reaction over the oxide support.

Hydrogen is dissociated on the Pt particles within the pore of Pt/KA-zeolite, and the spillover hydrogen migrates to the surrounding HY-zeolite and γ-alumina, where naphthalene molecules are adsorbed and hydrogenated.

### 4. Conclusions

The experimental results demonstrate that it is possible to design a new family of sulfur-resistant catalysts by combining the concepts of shape selectivity and hydrogen spillover. The catalysts of the present invention can find applications as catalysts and catalyst components for hydrogenation, dehydrogenation, isomerization, reforming, Fisher-Tropsch and selective oxidation processes, enhancing the overall reaction rate by supplying spillover hydrogen. They can also be used for membrane manufacture to increase the permeability and permselectivity of hydrogen in the separation of gas mixture or as membrane reactors for dehydrogenation and reforming.

This detailed description is used to illustrate the prime embodiments of the present invention. It will be apparent to those skilled in the art that various modifications can be made to the present methods and products and that various alternative embodiments can be utilized. Therefore, it will be recognized that modifications can be made in the present invention without departing from the scope of the invention, which is limited only by the appended claims.

1. A sulfur resistant catalyst comprising noble metal nano-particles contained in a zeolite cage having a final pore size of between about 2.9 Å and about 3.5 Å, wherein the zeolite cage is directly synthesized, or wherein the final pore size of the zeolite cage is reduced by post-treatments selected from chemical vapour deposition, chemical liquid deposition, cation exchange and combinations thereof to allow passage of hydrogen molecules into the cage while excluding organic sulfur molecules and wherein disassociated hydrogen species from reaction with the noble metal spill over through the zeolite pores to induce hydrogenation and to regenerate neighboring catalyst supports.

2. The catalyst of claim 1, wherein organic sulfur molecule is hydrogen sulfide.

3. The catalyst of claim 2, wherein the noble metal is selected from group VIIIB transition metals of the periodic table.

4. The catalyst of claim 3, wherein the noble metal is selected from the group consisting of Pt, Pd, Ru, Ir and Re.

5. The catalyst of claim 4, wherein the noble metal is platinum.

6. The catalyst of claim 1, wherein the zeolite cage is a directly synthesized, zeolite selected from a zeolite with an alpha or beta cage such as faujasite, LTA, RHO, sodalite.

7. The catalyst of claim 6, wherein the zeolites is LTA

8. The catalyst of claim 7, wherein the final pore size of the zeolite cage is reduced by a post-treatment method combining chemical vapour deposition and cation exchange.

9. The catalyst of claim 8, wherein the final pore size of the zeolite cage is reduced by cation exchange of potassium chloride and chemical vapour deposition of tetraethyoxysilane (TEOS).

10. A sulfur resistant catalyst comprising metal nano-particles selected from nickel, cobalt and tungsten, contained in a zeolite cage having a final pore size of between about 2.9 Å and about 3.5 Å, wherein the zeolite cage is directly synthesized, or wherein the final pore size of the zeolite cage is reduced by post-treatments selected from chemical vapour deposition, chemical liquid deposition, cation exchange and combinations thereof to allow passage of hydrogen molecules into the cage while excluding organic sulfur molecules and wherein disassociated hydrogen species from reaction with the metal spill over through the zeolite pores to induce hydrogenation and to regenerate neighboring catalyst supports.

11. A method of producing a sulfur resistant catalyst comprising noble metal nano-particles, said method comprising:
a. synthesizing a zeolite cage having a final pore size of between about 2.9 Å and about 3.5 Å to allow passage of hydrogen molecules into the cage while excluding organic sulfur molecules;
b. simultaneously incorporating a noble metal nano-particle into the zeolite cage during synthesis; and r
c. allowing disassociated hydrogen species from reaction with the noble metal to spill over through the zeolite pores to induce hydrogenation and to regenerate neighboring catalyst supports.

12. The method of claim 11, wherein the zeolite cage is selected from a zeolite with an alpha or beta cage.

13. The method of claim 12, wherein the zeolites is selected from the group consisting of faujasite, LTA, RHO and sodalite.

14. A method of producing a sulfur resistant catalyst comprising metal nano-particles selected from nickel, cobalt and tungsten, said method comprising:
a. synthesizing a zeolite cage having a final pore size of between about 2.9 Å and about 3.5 Å to allow passage of hydrogen molecules into the cage while excluding organic sulfur molecules;
b. simultaneously incorporating a noble metal nano-particle into the zeolite cage during synthesis; and
c. allowing disassociated hydrogen species from reaction with the noble metal to spill over through the zeolite pores to induce hydrogenation and to regenerate neighboring catalyst supports.

15. A method of producing a sulfur resistant catalyst comprising noble metal nano-particles, said method comprising:
a. incorporating the noble metal nano-particle into a zeolite cage;
b. reducing the size of pores in the zeolite cage to between about 2.9 Å and about 3.5 Å by a post treatment selected from chemical vapour deposition, chemical liquid deposition, cation exchange and combinations thereof to allow passage of hydrogen molecules into the cage while excluding organic sulfur molecules; and
c. allowing disassociated hydrogen species from reaction with the noble metal to spill over through the zeolite pores to induce hydrogenation and to regenerate neighboring catalyst supports.

16. The method of claim 15, wherein organic sulfur molecule is hydrogen sulfide.

17. The method of claim 16, wherein the noble metal is selected from group VIIIB transition metals of the periodic table.

18. The method of claim 17, wherein the noble metal is selected from the group consisting of Pt, Pd, Ru, Ir and Re.

19. The method of claim 18, wherein the noble metal is platinum.

20. The method of claim 19, wherein the final pore size of the zeolite cage is reduced by a post-treatment combining chemical vapour deposition and cation exchange.

21. The method of claim 20, wherein the final pore size of the zeolite cage is reduced by cation exchange of potassium chloride and chemical vapour deposition of tetraethyoxysilane (TEOS).

22. A method of producing a sulfur resistant catalyst comprising metal nano-particles selected from nickel, cobalt and tungsten, said method comprising:
a. incorporating the noble metal nano-particle into a zeolite cage;
b. reducing the size of pores in the zeolite cage to between about 2.9 Å and about 3.5 Å by a post treatment selected from chemical vapour deposition, chemical liquid deposition, cation exchange and combinations thereof to allow passage of hydrogen molecules into the cage while excluding organic sulfur molecules; and
c. allowing disassociated hydrogen species from reaction with the noble metal to spill over through the zeolite pores to induce hydrogenation and to regenerate neighboring catalyst supports.
